(19) United States
(12) Patent Application Publication
(10) Pub. No.: US 2011/0136032 A1
(43) Pub. Date: Jun. 9, 2011

(54) FUEL CELL SYSTEM AND ELECTRONIC DEVICE

(75) Inventors: Jusuke Shimura, Kanagawa (JP); Yoshiaki Inoue, Aichi (JP)

(73) Assignee: SONY CORPORATION, Tokyo (JP)

(21) Appl. No.: 13/059,011

(22) PCT Filed: Jul. 29, 2009
(86) PCT No.: PCT/JP2009/063506

§ 371 Date: Feb. 14, 2011

(30) Foreign Application Priority Data
Aug. 21, 2008 (JP) 2008-212830

(51) Int. Cl. H01M 8/04

(52) U.S. Cl. 429/447

(57) ABSTRACT

A fuel cell system with which flooding phenomenon of a fuel vaporization section is able to be suppressed without losing power generation characteristics is provided. In a fuel pump, upper limit frequency at which opening/closing operation of check valves is enabled is lower than mechanical resonance frequency of a piezoelectric body. Further, control is exercised so that oscillation frequency of the piezoelectric body is in the vicinity of the resonance frequency in a certain case. Thereby, while fuel supply operation by the fuel pump is stopped, a liquid fuel of the fuel pump is heated by oscillation of the piezoelectric body, and the heated liquid fuel is supplied to a fuel vaporization section. Further, since the generated heat is a heat amount generated by oscillation of the piezoelectric body, power generation characteristics in the power generation section are not lost differently from the case in the past.

### CROSS REFERENCE TO RELATED APPLICATIONS

The present application is a National Stage of International Application No. PCT/JP2009/063506 filed on Jul. 29, 2009 and which claims priority to Japanese Patent Application No. JP 2008-212830 filed on Aug. 21, 2008, the entire contents of which are being incorporated herein by reference.

### BACKGROUND

The present disclosure relates to a fuel cells. In the past, since fuel cells have high power generation efficiency and do not exhaust harmful matter, the fuel cells have been practically used as an industrial power generation equipment and a household power generation equipment, or as a power source for a satellite, a space ship or the like. Further, in recent years, the fuel cells have been progressively developed as a power source for a vehicle such as a passenger car, a bus, and a cargo truck. Such fuel cells are categorized into an alkali aqueous solution fuel cell, a phosphoric-acid fuel cell, a molten carbonate fuel cell, a solid oxide fuel cell, a direct methanol fuel cell and the like. Specially, a solid polyelectrolyte DMFC (Direct Methanol Fuel Cell) is able to provide a high energy density by using methanol as a fuel hydrogen source. Further, the DMFC does not need a reformer and thus is able to be downsized. Thus, the DMFC for a small mobile fuel cell has been progressively researched.

In the DMFC, an MEA (Membrane Electrode Assembly) as a unit cell in which a solid polyelectrolyte film is sandwiched between two electrodes, and the resultant is joined and integrated is used. One gas diffusion electrode is used as a fuel electrode (anode), and methanol as a fuel is supplied to the surface thereof. In the result, the methanol is decomposed, hydrogen ions (protons) and electrons are generated, and the hydrogen ions pass through the solid polyelectrolyte film. Further, the other gas diffusion electrode is used as an oxygen electrode (cathode), and air as oxidant gas is supplied to the surface of thereof. In the result, oxygen in the air is bonded to the foregoing hydrogen ions and the foregoing electrons to generate water. Such electrochemical reaction results in generation of electro motive force from the DMFC.

In such a DMFC, as a method of supplying methanol to the fuel electrode, a liquid supply type fuel cell (a liquid fuel (methanol aqueous solution) is directly supplied to the fuel electrode) and a vaporization supply type fuel cell (a vaporized liquid fuel is supplied to the fuel electrode) are proposed. Of the foregoing, in the vaporization supply type fuel cell, there is a problem that since temperature of the fuel vaporization section is decreased as a fuel is vaporized, generated water is easily condensed in the fuel vaporization section. Such water condensation is also called flooding phenomenon. In particular, the flooding phenomenon is significantly shown at low atmosphere temperature, which has been a factor to cause power generation fault at the time of long time usage in cold regions.

Examples of methods to prevent such water condensation in the fuel vaporization section include a method to previously warm the fuel vaporization section. However, in this method, it is necessary to separately provide a heater for warming. In addition, there is a disadvantage that energy is wasted for warming the whole area of the fuel vaporization section.

Thus, as one of the methods to prevent the flooding phenomenon without using the heater for warming, a method of heating the fuel vaporization section by heat generated in the power generation section has been proposed (for example, Patent Document 1).

### CITATION LIST

### Patent Document

Patent document 1: Japanese Unexamined Patent Application Publication No. 2008-27817

### SUMMARY

In the method in the foregoing Patent Document 1, however, there has been a problem that since temperature of the power generation section is decreased, catalyst activity is lowered and power generation performance itself is sacrificed (power generation characteristics are impaired).

In view of the foregoing problems, it is desired to provide a fuel cell system with which the flooding phenomenon in the fuel vaporization section is able to be inhibited without losing the power generation characteristics and an electronic device including such a fuel cell system.

A fuel cell system of an embodiment includes: a power generation section performing power generation by being supplied a fuel and oxidant gas; a piezoelectric pump section including a piezoelectric body and a check valve, and supplying a liquid fuel to the power generation section side; a fuel vaporization section supplying a gas fuel to the power generation section by vaporizing the liquid fuel supplied from the piezoelectric pump section; and a control section adjusting a supply amount of the liquid fuel supplied from the piezoelectric pump section by controlling oscillation frequency of the piezoelectric body. Here, upper limit frequency at which opening/closing operation of the check valve is enabled is lower than mechanical resonance frequency of the piezoelectric body. Further, the control section exercises control so that the oscillation frequency of the piezoelectric body is in the vicinity of the resonance frequency in a certain case.

In addition, “opening/closing operation of the check valve is enabled” state includes not only a state in which the check valve is able to totally perform opening/closing operation, but also a state that almost no supply operation of the liquid fuel is performed even if opening/closing operation is slightly performed. In other words, “upper frequency at which opening/closing operation of the check valve is enabled” means, for example, frequency at which supply amount of the liquid fuel is decreased down to, for example about one tenth or less of the maximum value due to mechanism in which opening/closing operation of the check valve is not able to follow operation of the piezoelectric body when, for example, the operation frequency of the check valve is gradually increased from the rated value. Further, “mechanical resonance frequency of the piezoelectric body” means, for example, mechanical resonance frequency at which the amplitude value of the piezoelectric body is the maximum.

An electronic device of an embodiment includes the foregoing fuel cell system.

In the fuel cell system and the electronic device of an embodiment, the liquid fuel supplied from the piezoelectric pump section is vaporized in the fuel vaporization section, and thereby the gas fuel is supplied to the power generation section. Further, in the power generation section, power generation is performed by being supplied the gas fuel and oxidant gas. And, oscillation frequency of the piezoelectric body in the piezoelectric pump section is controlled, and thereby the supply amount of the liquid fuel supplied from the piezoelectric pump section is adjusted. At this time, in a certain case, control is exercised so that the oscillation frequency of the piezoelectric body is in the vicinity of the mechanical resonance frequency of the piezoelectric body. Here, the upper limit frequency at which opening/closing operation of the check valve is enabled is lower than the mechanical resonance frequency of the piezoelectric body. Thus, in the case where the oscillation frequency of the piezoelectric body becomes in the vicinity of the foregoing resonance frequency, opening/closing operation of the check valve is stopped, and fuel supply operation by the piezoelectric pump section is stopped. Further, the liquid fuel in the piezoelectric pump section is heated by oscillation of the piezoelectric body, and the heated liquid fuel is supplied to the fuel vaporization section.

In the fuel cell system of an embodiment, the foregoing upper limit frequency may be in a value in the audible frequency region, and the foregoing control section may exercise control so that the oscillation frequency of the piezoelectric body is higher than the foregoing upper limit frequency in the audible frequency region. In this case, since the oscillation frequency of the piezoelectric body is higher than the foregoing upper limit frequency, opening/closing operation of the check valve is stopped, and fuel supply operation by the piezoelectric pump section is stopped. Further, since the oscillation frequency of the piezoelectric body is in the audible frequency region, audible sound is generated by oscillation of the piezoelectric body. Thus, in a certain case, sound effect or the like is able to be generated to a user without separately providing a member such as a speaker.

According to the fuel cell system or the electronic device of an embodiment, in the piezoelectric pump section, the upper limit frequency at which opening/closing operation of the check valve is enabled is set to a lower value than that of the mechanical resonance frequency of the piezoelectric body, and the oscillation frequency of the piezoelectric body becomes in the vicinity of the mechanical resonance frequency in a certain case. Thus, it is possible that while fuel supply operation by the piezoelectric pump section is stopped, the liquid fuel in the piezoelectric pump section is heated by oscillation of the piezoelectric body, and the heated liquid fuel is able to be supplied to the fuel vaporization section. Further, since the heat is the heat amount generated by oscillation of the piezoelectric body, power generation characteristics in the power generation section are not lost differently from the case in the past. Thus, flooding phenomenon of the fuel vaporization section is able to be inhibited without losing the power generation characteristics.

Additional features and advantages are described herein, and will be apparent from, the following Detailed Description and the figures.

### BRIEF DESCRIPTION OF THE FIGURES

FIG. 1 is a block diagram illustrating a whole configuration of a fuel cell system according to an embodiment.

FIG. 2 is a cross sectional view illustrating a configuration example of the power generation section illustrated in FIG. 1.

FIG. 3 is a plan view illustrating a configuration example of the power generation section illustrated in FIG. 1.

FIG. 4 is a cross sectional view schematically illustrating a detailed structure of a fuel pump.

FIG. 5 is a timing diagram illustrating relation between position of a piezoelectric body and operation state of the fuel pump.

FIG. 6 is a characteristics diagram for explaining summary of a vaporized fuel supply method.

FIG. 7 is a characteristics diagram illustrating relation between oscillation frequency of the piezoelectric body and operation state of the fuel pump.

FIG. 8 is a cross sectional view for explaining a method of manufacturing the power generation section illustrated in FIG. 1.

FIG. 9 is a plan view for explaining a method of manufacturing the power generation section illustrated in FIG. 1.

FIG. 10 is a characteristics diagram illustrating an example of relation between oscillation frequency of the piezoelectric body and temperature of the piezoelectric pump/impedance.

### DETAILED DESCRIPTION

An embodiment will be hereinafter described in detail with reference to the drawings.

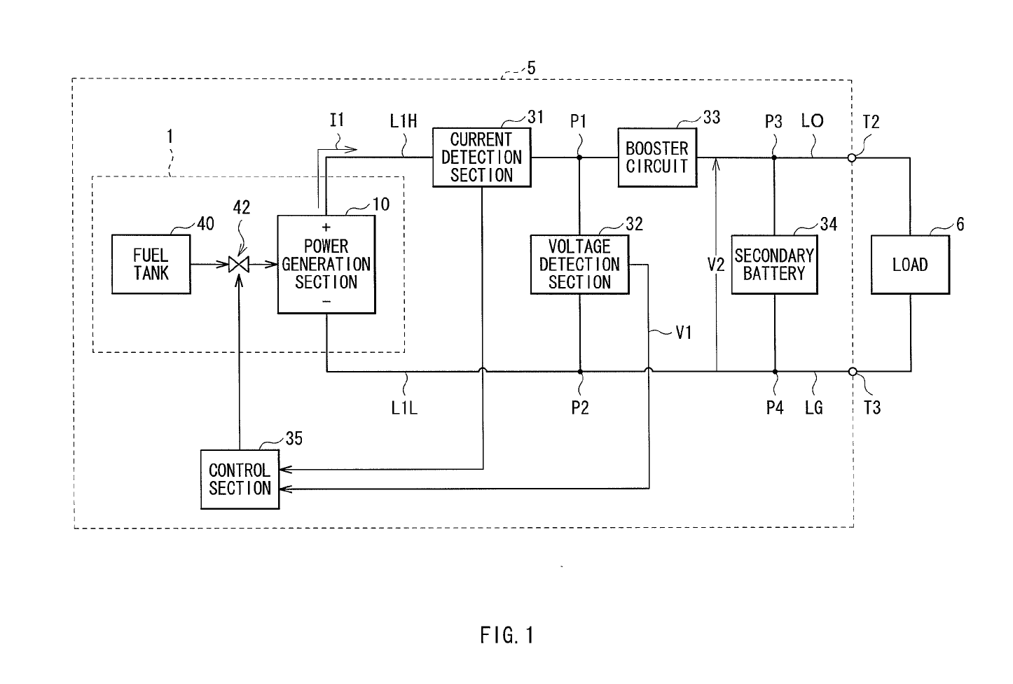

FIG. 1 illustrates a whole configuration of a fuel cell system (fuel cell system 5) according to an embodiment of the present invention. The fuel cell system 5 supplies electric power for driving a load 6 through output terminals T2 and T3. The fuel cell system 5 is composed of a fuel cell 1, a current detection section 31, a voltage detection section 32, a booster circuit 33, a secondary battery 34, and a control section 35.

The fuel cell 1 includes a power generation section 10, a fuel tank 40, and a fuel pump 42. In addition, the detailed structure of the fuel cell 1 will be described later.

The power generation section 10 is a direct methanol power generation section for performing power generation by reaction between methanol and oxidant gas (for example, oxygen). The power generation section 10 includes a plurality of unit cells having a cathode (oxygen electrode) and an anode (fuel electrode). In addition, the detailed structure of the power generation section 10 will be described later.

The fuel tank 40 includes a liquid fuel necessary for power generation (for example, methanol or methanol aqueous solution). In addition, the detailed structure of the fuel tank 40 will be described later.

The fuel pump 42 is a pump for pumping up the liquid fuel contained in the fuel tank 40 and supplying (transporting) the liquid fuel to the power generation section 10 side. The fuel pump 42 is able to adjust supply amount of the fuel. The fuel pump 42 is composed of a piezoelectric pump. Further such operation (supply operation of the liquid fuel) of the fuel pump 42 is controlled by the after-mentioned control section 35. In addition, the detailed structure of the fuel pump 42 will be described later.

The current detection section 31 is arranged between the cathode side of the power generation section 10 and a connection point P1 on a connection line L1H and is intended to detect a power generation current I1 of the power generation section 10. The current detection section 31 includes, for example, a resistor. In addition, the current detection section 31 may be arranged on a connection line L1L (between the anode side of the power generation section 10 and a connection point P2).

The voltage detection section 32 is arranged between the connection point P1 on the connection line L1H and the connection point P2 on the connection line L1L. The voltage detection section 32 is intended to detect a power generation voltage V1 of the power generation section 10. The voltage detection section 32 includes, for example, a resistor.

The booster circuit 33 is arranged between the connection point P1 on the connection line L1H and a connection point P3 on an output line LO. The booster circuit 33 is a voltage converter that increases the power generation voltage V1 (DC voltage) of the power generation section 10 and generates a DC voltage V2. The booster circuit 33 is composed of, for example, a DC/DC converter.

The secondary battery 34 is arranged between the connection point P3 on the output line LO and a connection point P4 on a ground line LG. The secondary battery 34 is intended to perform electric storage based on the DC voltage V2 generated by the booster circuit 33. The secondary battery 34 is composed of, for example, a lithium ion secondary battery or the like.

The control section 35 is intended to adjust supply amount of the liquid fuel by the fuel pump 42 based on the power generation current (detected current) I1 detected by the current detection section 31 and the power generation voltage (detection voltage) V1 detected by the voltage detection section 32. Specifically, the control section 35 is intended to adjust supply amount of the liquid fuel by the fuel pump 42 by controlling oscillation frequency f of a piezoelectric body (after-mentioned piezoelectric body 422) in the fuel pump 42. Such a control section 35 is composed of, for example, a micro computer or the like. In addition, the detailed operation of the control section 35 will be described later.

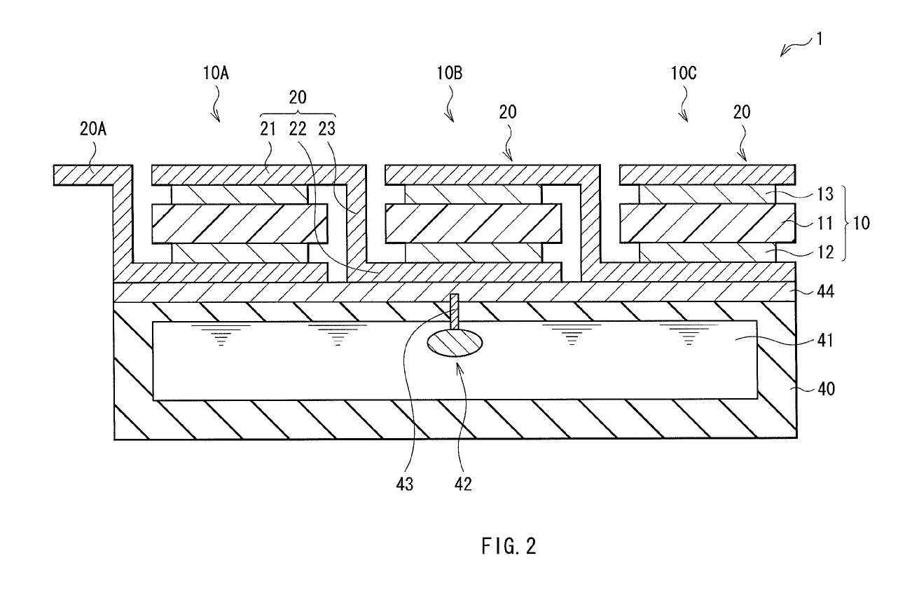

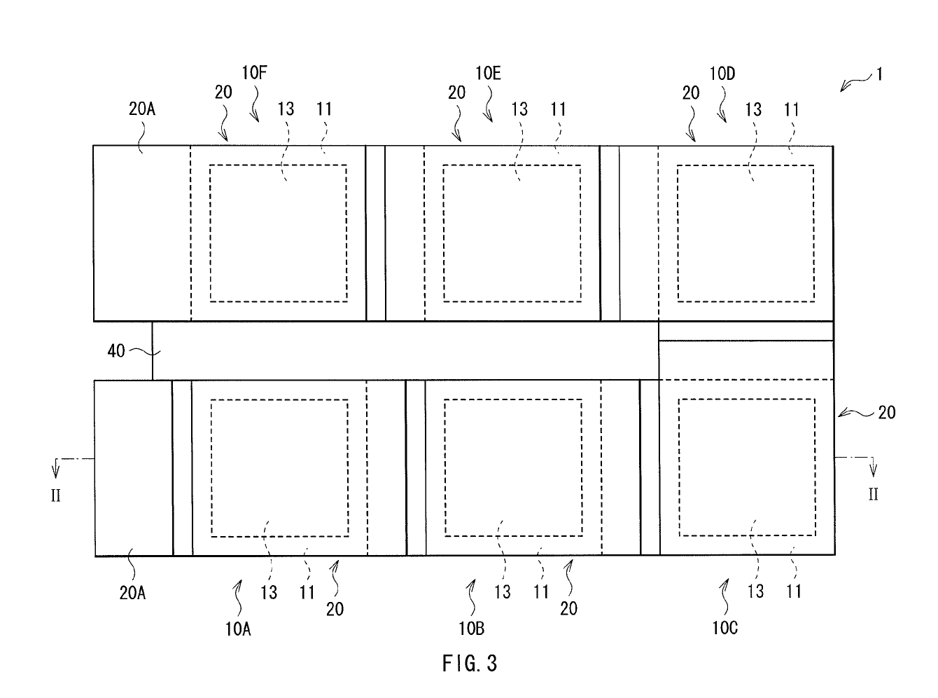

Next, a description will be given in detail of a detailed structure of the fuel cell 1 with reference to FIG. 2 to FIG. 7. FIG. 2 and FIG. 3 illustrate a structural example of unit cells 10A to 10F in the power generation section 10 in the fuel cell 1. FIG. 2 corresponds to a cross sectional structure taken along line II-II of FIG. 3. The unit cells 10A to 10F are arranged, for example, in a matrix of three by two in the in-plane direction, and has a planar laminated structure in which each thereof is electrically connected to each other in series by a plurality of connection members 20. A terminal 20A as an extension section of the connection members 20 is attached to the unit cells 10A and 10F. Further, below the unit cells 10A to 10F, the fuel tank 40, the fuel pump 42, a nozzle 43, and a fuel vaporization section 44 are provided.

The unit cells 10A to 10F each have a fuel electrode (anode, anode electrode) 12 and an oxygen electrode 13 (cathode, cathode electrode) that are oppositely arranged with an electrolyte film 11 in between.

The electrolyte film 11 is made of, for example, a proton conductive material having a sulfonate group (—SO₃H). Examples of proton conductive materials include a polyperfluoroalkyl sulfonic acid proton conductive material (for example, “Nafion (registered trademark),” manufactured by Du Pont), a hydrocarbon system proton conductive material such as polyimide sulfone acid, and a fullerene system proton conducive material.

The fuel electrode 12 and the oxygen electrode 13 have, for example, a structure in which a catalyst layer containing a catalyst such as platinum (Pt) and ruthenium (Ru) is formed on a current collector made of, for example, carbon paper. The catalyst layer is, for example, a layer in which a supporting body such as carbon black supporting a catalyst is dispersed in a polyperfluoroalkyl sulfonic acid-based proton conductive material or the like. In addition, an air supply pump (not illustrated) may be connected to the oxygen electrode 13. Otherwise, the oxygen electrode 13 may communicate with outside through an aperture (not illustrated) provided in the connection member 20, and air, that is, oxygen may be supplied therein by natural ventilation.

The connection member 20 has a bend section 23 between two flat sections 21 and 22. The flat section 21 is contacted with the fuel electrode 12 of one unit cell (for example, 10A), and the flat section 22 is contacted with the oxygen electrode 13 of an adjacent unit cell (for example, 10B), and thereby the adjacent two unit cells (for example, 10A and 10B) are electrically connected in series. Further, the connection member 20 has a function as a current collector to collect electricity generated in the respective unit cells 10A to 10F. Such a connection member 20 has, for example, a thickness of 150 μm, is composed of copper (Cu), nickel (Ni), titanium (Ti), or stainless steel (SUS), and may be plated with gold (Au), platinum (Pt) or the like. Further, the connection member 20 has an aperture (not illustrated) for respectively supplying a fuel and air to the fuel electrode 12 and the oxygen electrode 13. The connection member 20 is made of, for example, mesh such as an expanded metal, a punching metal or the like. The bend section 23 may be previously bent according to the thickness of the unit cells 10A to 10F. Otherwise, in the case where the connection member 20 is made of a material having flexibility such as mesh having a thickness of 200 μm or less, the bend section 23 may be formed by being bent in a manufacturing step. Such a connection member 20 is joined with the unit cells 10A to 10F by, for example, screwing a sealing material (not illustrated) such as PPS (polyphenylene sulfide) and silicon rubber provided around the electrolyte film 11 into the connection member 20.

The fuel tank 40 is, for example, composed of a container with a cubic volume changeable without intrusion of air bubbles or the like therein even if the liquid fuel 41 is increased or decreased (for example, a plastic bag), and a rectangular solid case (structure) to cover the container. The fuel tank 40 is provided with the fuel pump 42 for suctioning the liquid fuel 41 in the fuel tank 40 and discharging the suctioned liquid fuel 41 from the nozzle 43 in a position above approximately center of the fuel tank 40.

The fuel vaporization section 44 is intended to vaporize the liquid fuel supplied from the fuel pump 42 and thereby to supply the vaporized fuel to the power generation section 10 (respective unit cells 10A to 10F). That is, the fuel vaporization section 44 is arranged between the fuel pump 42 and the power generation section 10. Such a fuel vaporization section 44 is structured by providing a diffusion section (not illustrated) for promoting diffusion of the fuel on a plate (not illustrated) made of, for example, a metal or an alloy containing stainless steel, aluminum, or the like, or a resin material with high rigidity, such as cycloolefin copolymer (COC). As the diffusion section, an inorganic porous material such as alumina, silica, and titanium oxide or a resin porous material is able to be used.

The nozzle 43 is a jetting port of the fuel transported through a flow path (not illustrated) of the fuel pump 42, and ejects the fuel toward the diffusion section provided on the surface of the fuel vaporization section 44. Thereby, the fuel transported to the fuel vaporization section 44 is diffused and vaporized, and is supplied to the power generation section 10 (respective unit cells 10A to 10F). The nozzle 43 has a bore diameter with a diameter from 0.1 mm to 0.5 mm both inclusive, for example.

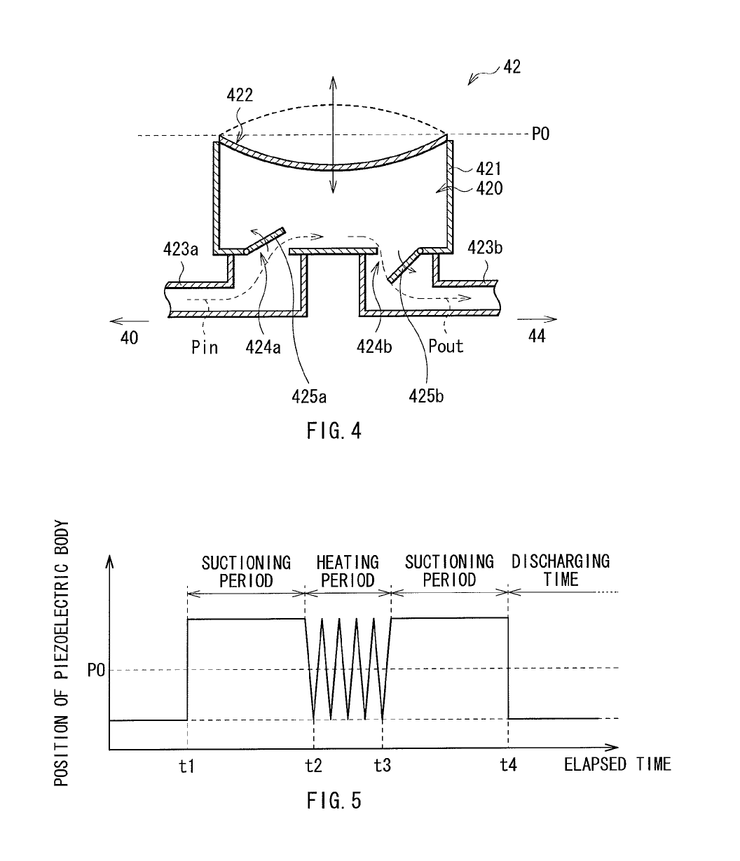

Here, a description will be given of a detailed structure of the fuel pump 42 with reference to FIG. 4 to FIG. 7. FIG. 4 schematically illustrates a cross sectional structure of the fuel pump 42.

The fuel pump 42 is composed of a pump chamber 420 formed from a container 421 and the piezoelectric body 422, a pair of flow paths 423a and 423b as a pipe to connect the fuel tank 40 with the nozzle 43, and a pair of check valves 425a and 425b. As indicated by arrows in FIG. 4, the fuel pump 42 is a piezoelectric pump for sending the liquid fuel 41 from the fuel tank 40 side to the fuel vaporization section 44 side through the path indicated by arrows Pin and Pout in the figure by using bend deformation of the piezoelectric body 422 functioning as an actuator and opening/closing operation of the check valves 425a and 425b.

The piezoelectric body 422 forms the top face of the pump chamber 420, and contains a piezoelectric device such as lead zirconium titanate (PZT). The piezoelectric body 422 has characteristics to generate heat when deformed. In particular, in the case where the piezoelectric body 422 is oscillated at frequency in the vicinity of its mechanical resonance frequency (natural frequency) f_{E} (for example, about 45 kHz), significantly large bend deformation is generated, and heat generation is thereby increased.

The check valve 425a is provided in a suction hole 424a section in the pump chamber 420. The suction hole 424a is provided in a connection part between the pump chamber 420 and the flow path 423a on the fuel tank 40 side. Meanwhile, the check valve 425b is provided in a discharge hole 424b section in the pump chamber 420. The discharge hole 424b is provided in a connection part between the pump chamber 420 and the flow path 423b on the fuel vaporization section 44 side. As described above, two check valves 425a and 425b are provided on the inflow side and the outflow side of the liquid fuel 41, and thereby unidirectional flow of the liquid fuel 41 is maintained. The check valves 425a and 425b have a characteristic in which when the drive frequency thereof is increased, valve opening/closing operation of the check valves 425a and 425b becomes insufficient accordingly, resulting in a state that the fuel is hardly supplied.

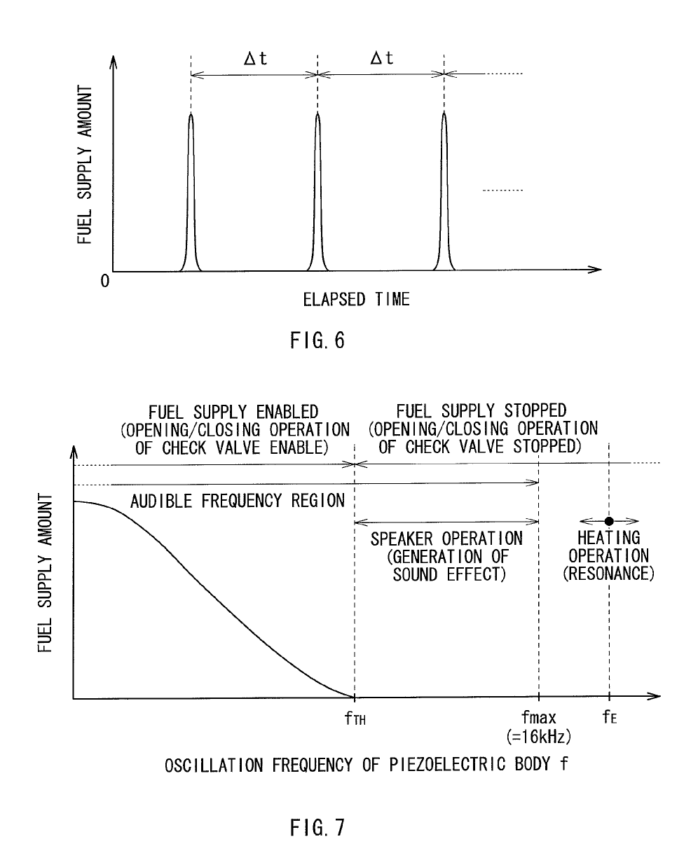

Thereby, for example, as indicated by timings t1 to t4 in FIG. 5, in the fuel pump 42, suctioning period of the liquid fuel 41 (for example, period between timings t1 and t2 and period between timings t3 and t4) and discharging period of the liquid fuel 41 (for example, period on and after the timing t4) are provided according to position of the piezoelectric body 422. Further, supply amount of the liquid fuel 41 is able to be adjusted according to change of the oscillation frequency f of the piezoelectric body 422, fuel supply amount per one operation, or change of fuel supply cycle Δt (refer to FIG. 6).

In the fuel pump 42 of this embodiment, for example, as illustrated in FIG. 7 and Formula (1), the upper limit frequency at which opening/closing operation of the check valves 425a and 425b is enabled (threshold frequency f_{TH}: for example, about 40 Hz) is lower than the foregoing mechanical resonance frequency f_{E} of the piezoelectric body 422.

f_{TH}<f_{E} (1)

Further, the control section 35 is intended to exercise control so that the oscillation frequency f of the piezoelectric body 422 becomes in the vicinity of the mechanical resonance frequency f_{E} of the piezoelectric body 422 (preferably the resonance frequency f_{E}) in a certain case. Specifically, the control section 35 exercises control so that the oscillation frequency f of the piezoelectric body 422 becomes in the vicinity of the resonance frequency f_{E} regularly or when temperature of the fuel vaporization section 44 becomes lower than given threshold temperature (for example, about (temperature of the power generation section 10 −5 deg C.).

Thereby, though detailed description will be given later, for example, as in the heating period illustrated in FIG. 5 (period between the timings t2 and t3), the liquid fuel 41 in the fuel pump 42 is heated by oscillation of the piezoelectric body 422, and the heated liquid fuel 41 is supplied to the fuel vaporization section 44. In addition, the mechanical resonance frequency f_{E} of the piezoelectric body 422 is preferably higher than the upper limit value in audible frequency region (fmax=about 16 kHz) for the following reason. That is, in the case where the resonance frequency f_{E} becomes the upper limit value or less, audible sound is generated in such a heating period.

Further, in the fuel pump 42 of this embodiment, for example, as illustrated in FIG. 7, in the case where the upper limit frequency of the check valves 425a and 425b (threshold frequency f_{TH}) is a value in the audible frequency region, the control section 35 may exercise control so that the oscillation frequency f of the piezoelectric body 422 is higher than the threshold frequency f_{TH} in the audible frequency region in a certain case. That is, the oscillation frequency f of the piezoelectric body 422 may satisfy the following Formula (2).

f_{TH}<f<fₘₐₓ (2)

Specific examples of the foregoing “certain case” include the following cases. First, a case of changing the fuel tank 40 in the case where the fuel tank 40 is detachable, a case of injecting the liquid fuel into the fuel tank 40. In addition, a case of power generation anomaly in the power generation section 10, and a case of detecting a precursory of the power generation anomaly (for example, a case of detecting oxygen-deprived state or the like).

The foregoing description may be supported by the following reason. That is, in the past, for example, in the case where change operation of a fuel cartridge by a user is insufficient, in the case where fuel injection into a built-in tank is insufficient, or in the case where an air inlet is blocked and oxygen supply to the air electrode is stopped, if such a state is not solved immediately, there has been a possibility that power supply is unexpectedly stopped. As a possible method to prevent such a state, for example, there is a method to generate sound effect to promote a user to address the state in the case where a fuel cartridge is correctly changed, in the case where power generation anomaly occurs, or in the case where a precursory of the power generation anomaly is detected, for example. However, if a speaker, a buzzer or the like is separately provided, cost for the member is increased, and an electronic circuit for driving the speaker or the like should be provided.

Meanwhile, in the fuel pump 42 of this embodiment, in the case where the foregoing Formula (2) is satisfied, since the oscillation frequency f of the piezoelectric body 422 is higher than the upper limit frequency (threshold frequency f_{TH}), opening/closing operation of the check valves 425a and 425b is stopped, and fuel supply operation by the fuel pump 42 is stopped. Further, since the oscillation frequency f of the piezoelectric body 422 is in the audible frequency region, audible sound is generated by oscillation of the piezoelectric body 422. Thus, in the foregoing “certain case,” sound effect or the like is able to be generated to a user without separately providing a member such as a speaker. Further, since fuel supply operation is stopped, only sound effect is able to be generated without influencing inherent power generation operation in the power generation section 10.

The fuel cell system 5 of this embodiment is able to be manufactured, for example, as follows.

First, the electrolyte film 11 made of the foregoing material is sandwiched between the fuel electrode 12 and the oxygen electrode 13 made of the foregoing material. The resultant is joined by thermal compression bond. Thereby, the fuel electrode 12 and the oxygen electrode 13 are joined with the electrolyte film 11 to form the unit cells 10A to 10F.

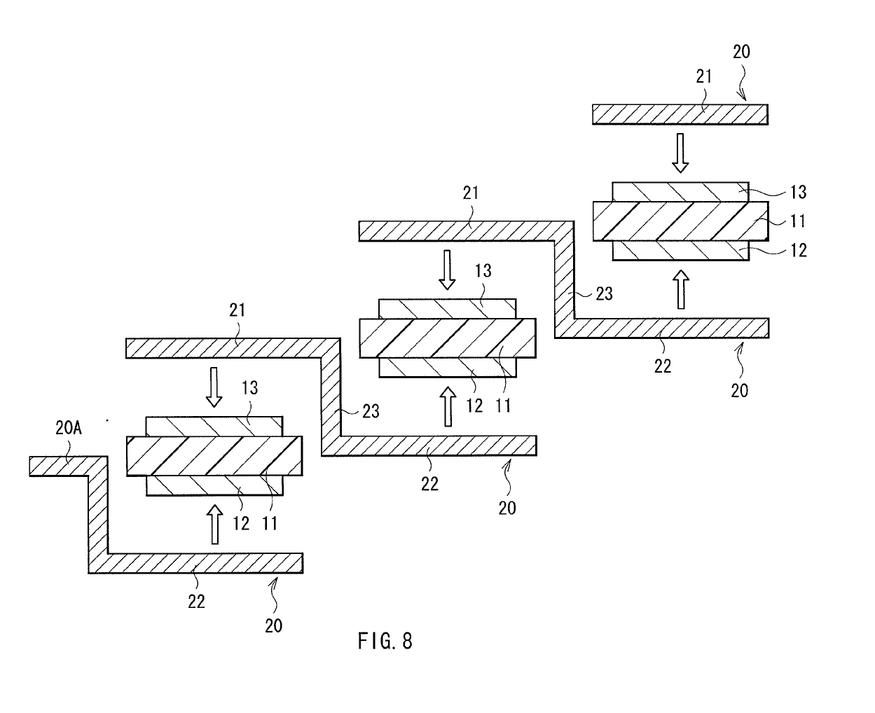

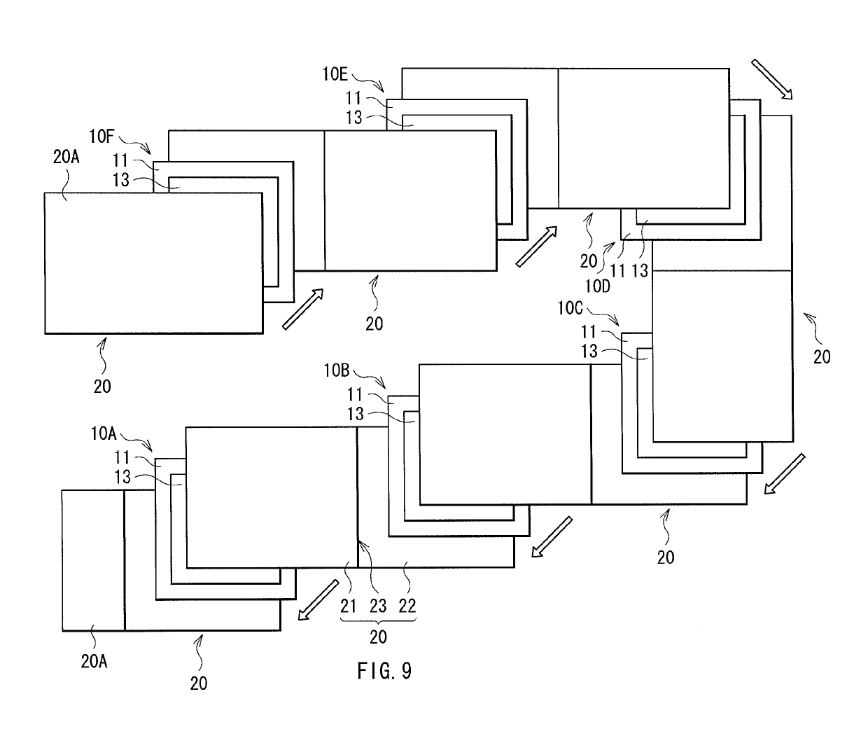

Next, the connection member 20 made of the foregoing material is prepared. As illustrated in FIG. 8 and FIG. 9, the six unit cells 10A to 10F are arranged in a matrix of three by two, and are electrically connected to each other in series by the connection member 20. In addition, the sealing material (not illustrated) made of the foregoing material is provided around the electrolyte film 11, and the sealing material is screwed and fixed on the bend section 23 of the connection member 20.

After that, the fuel tank 40 that contains the liquid fuel 41 and is provided with the fuel pump 42, the nozzle 43 and the like is arranged on the fuel electrode 12 side of the linked unit cells 10A to 10F, and thereby the fuel cell 1 is formed. The foregoing current detection section 31, the voltage detection section 32, the booster circuit 33, the secondary battery 34, and the control section 35 are electrically connected in parallel to the fuel cell 1 respectively as illustrated in FIG. 1. Accordingly, the fuel cell system 5 illustrated in FIG. 1 to FIG. 4 is completed.

Next, a description will be given in detail of operation and effect of the fuel cell system 5 of this embodiment.

In the fuel cell system 5, the liquid fuel 41 contained in the fuel tank 40 is pumped up by the fuel pump 42, and thereby the liquid fuel 41 passes through the flow path 423a, the check valve 425a, the pump chamber 420, the check valve 425b, and the flow path 423b in this order, and reaches the fuel vaporization section 44. Further, in the fuel vaporization section 44, in the case where the liquid fuel is ejected by the nozzle 43, the fuel is diffused over a wide range by the diffusion section (not illustrated) provided on the surface thereof. Thereby, the liquid fuel 41 is naturally vaporized, and the gas fuel is supplied to the power generation section 10 (specifically, the fuel electrodes 12 of the respective unit cells 10A to 10F).

Meanwhile, air (oxygen) is supplied to the oxygen electrode 13 of the power generation section 10 by natural ventilation or an air supply pump (not illustrated). Then, in the oxygen electrode 13, reaction shown in the following Formula (3) is generated, and hydrogen ions and electrons are generated. The hydrogen ions reach the fuel electrode 12 through the electrolyte film 11. In the fuel electrode 12, reaction shown in the following Formula (4) is generated, and water and carbon dioxide are generated. Thus, as the entire fuel cell 1, reaction shown in the following Formula (5) is generated, and power generation is performed.

CH₃OH+H₂O→CO₂6H⁺+6e⁻ (3)

6H⁺+(3/2)O₂+6e⁻→3H₂O (4)

CH₃OH+(3/2)O₂→CO₂+2H₂O (5)

Thereby, part of chemical energy of the liquid fuel 41, that is, methanol is converted to electric energy, which is collected by the connection member 20 and is extracted as a current (output current I1) from the power generation section 10. The power generation voltage (DC voltage) V1 based on the power generation current I1 is increased (voltage conversion) by the booster circuit 33 and becomes the DC voltage V2. The DC voltage V2 is supplied to the secondary battery 34 or a load (for example, an electronic device body). In the case where the DC voltage V2 is supplied to the secondary battery 34, the secondary battery 34 is charged based on the voltage. Meanwhile, in the case where the DC voltage V2 is supplied to the load 6 through the output terminals T2 and T3, the load 6 is driven, and given operation is made.

At this time, in the fuel pump 42, the fuel supply amount per one operation or the fuel supply cycle Δt and the oscillation frequency f of the piezoelectric body 422 in the fuel pump 42 are controlled by the control section 35, and accordingly the fuel supply amount is adjusted.

At this time, in the fuel cell system 5 of this embodiment, as illustrated in FIG. 7, in the foregoing “certain case,” control is exercised so that the oscillation frequency f of the piezoelectric body 422 becomes in the vicinity of the mechanical resonance frequency f_{E} of the piezoelectric body 422. Further, the upper limit frequency (threshold frequency f_{TH}) at which opening/closing operation of the check valves 425a and 425b is enabled is lower than the mechanical resonance frequency f_{E} of the piezoelectric body 422.

Thereby, when the oscillation frequency f of the piezoelectric body 422 becomes in the vicinity of the foregoing resonance frequency f_{E}, opening/closing operation of the check valves 425a and 425b is stopped, and fuel supply operation by the fuel pump 42 is stopped as well. Further, the liquid fuel 41 in the fuel pump 42 is heated by oscillation of the piezoelectric body 422. That is, only the piezoelectric body 422 as an actuator is able to be heated while sending almost no liquid. Thus, since the piezoelectric body 422 is located in the vicinity of the pump chamber 420, only the liquid fuel 41 in the pump chamber 420 is selectively and effectively heated. Then, the liquid fuel 41 heated as above is supplied to the fuel vaporization section 44. Thereby, in the fuel vaporization section 44, temperature lowering due to vaporization heat is suppressed. In the piezoelectric body 422, heat amount generated by oscillation of the oscillation frequency f in the vicinity of the resonance frequency f_{E} is preferably almost equal to the vaporization heat of the liquid fuel 41. If such heat amount is generated, temperature lowering by the vaporization heat in the fuel vaporization section 44 is totally prevented.

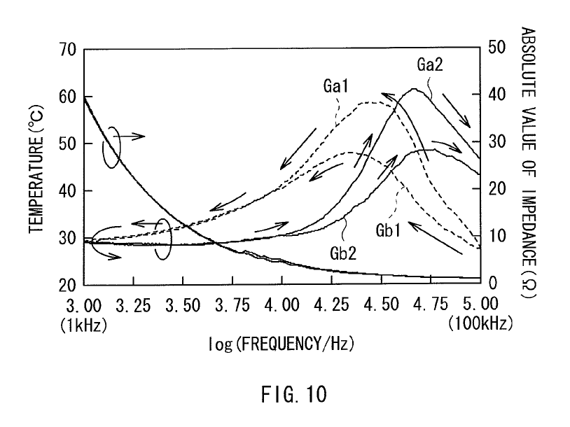

Here, FIG. 10 illustrates measurement results obtained by observing change of temperature and impedance in two locations (point A and point B) of the fuel pump 42 body under the following conditions. That is, an AC voltage (AC frequency: 100 kHz, 1 Vpp) was applied to the fuel pump 42 in which the upper limit frequency (threshold frequency f_{TH}) of the check valves 425a and 425b was about 40 Hz, the resonance frequency f_{E} of the piezoelectric body 422 was about 45 kHz, and rated drive voltage was 12 Vpp, and sweeping was made in order of 100 kHz, 1 kHz, 100 kHz and so on.

First, as indicated by arrows in referential symbols Ga1 and Gb1 in the figure, in the case where the oscillation frequency f of the piezoelectric body 422 was decreased from 100 kHz to 1 kHz, temperature of the point A and temperature of the point B (respectively indicated by the referential symbols Ga1 and Gb1) was increased. In the result, temperature of the point A became the maximum temperature 59 deg C. at the time of the oscillation frequency f=28 kHz, while temperature of the point B became the maximum temperature 48 deg C. at the time of the oscillation frequency f=27 kHz. In the case where the oscillation frequency f is decreased, both temperature of the points A and B was decreased.

Next, as indicated by arrows in referential symbols Ga2 and Gb2 in the figure, in the case where the oscillation frequency f of the piezoelectric body 422 was increased from 1 kHz to 100 kHz, temperature of the point A and temperature of the point B (respectively indicated by the referential symbols Ga2 and Gb2) was increased again. In the result, temperature of the point A became the maximum temperature 61 deg C. at the time of the oscillation frequency f=50 kHz, while temperature of the point B became the maximum temperature 47 deg C. at the time of the oscillation frequency f=54 kHz. Further, in the case where the oscillation frequency f was further increased, both temperature of the points A and B was decreased.

From these results, it was shown that by applying only 1 Vpp AC voltage, the fuel pump 42 effectively generated heat. Further, it was shown that since the check valves 425a and 425b hardly operated in the case where the resonance frequency f_{E} of the piezoelectric body 422 was in the vicinity of 45 kHz, by applying about 45 kHz AC voltage to the fuel pump 42, heating is effectively made while the liquid fuel 41 was retained in the pump chamber 420.

Accordingly, in this embodiment, in the fuel pump 42, the upper limit frequency (threshold frequency f_{TH}) at which opening/closing operation of the check valves 425a and 425b is enabled is set to a lower value than that of the mechanical resonance frequency f_{E} of the piezoelectric body 422, and the oscillation frequency f of the piezoelectric body 422 becomes in the vicinity of the resonance frequency f_{E} in a certain case. Thus, it is possible that while fuel supply operation by the fuel pump 42 is stopped, the liquid fuel 41 of the fuel pump 42 is heated by oscillation of the piezoelectric body 422, and the heated liquid fuel 41 is able to be supplied to the fuel vaporization section 44. Further, since the heat is the heat amount generated by oscillation of the piezoelectric body 422, power generation characteristics in the power generation section 10 are not lost differently from the case in the past. Thus, flooding phenomenon of the fuel vaporization section 44 is able to be suppressed without losing the power generation characteristics.

Further, since direct heating is enabled with the use of the fuel pump 42 without separately providing a member such as a heater, cost for the member is able to be inhibited. Further, in addition, this embodiment contributes to space saving, and the control circuit is able to be simplified.

Further, in the case where in the piezoelectric body 422, the heat amount generated by oscillation of the oscillation frequency f in the vicinity of the resonance frequency f_{E} is almost equal to the vaporization heat of the liquid fuel 41, temperature lowering by the vaporization heat in the fuel vaporization section 44 is totally prevented. Thus, water condensation (flooding phenomenon) in the fuel vaporization section 44 is able to be totally avoided.

Further, in the case where the upper limit frequency of the check valves 425a and 425b (threshold frequency f_{TH}) is a value in the audible frequency region, if the oscillation frequency f of the piezoelectric body 422 is higher than the threshold frequency f_{TH} in the audible frequency region in a certain case (if the oscillation frequency f of the piezoelectric body 422 satisfies the foregoing Formula (2)), sound effect or the like is able to be generated to a user without separately providing a member such as a speaker and without influencing inherent power generation operation in the power generation section 10 in a certain case. Thus, instead of separately mounting a speaker, a buzzer or the like, a sound effect is generated after, for example, the fuel cartridge is loaded correctly or after blocking of the air electrode is detected. Thereby, such a state is noticed to a user, and a state that power supply is unexpectedly stopped is able to be avoided.

In the foregoing embodiment, the description has been given of the case that the mechanical resonance frequency f_{E} of the piezoelectric body 422 is higher than the upper limit value in the audible frequency region (fmax=about 16 kHz). However, for example, in the case where generated audible sound is hardly heard, the mechanical resonance frequency f_{E} of the piezoelectric body 422 is not necessarily higher than the upper limit value in the audible frequency region (fmax=about 16 kHz).

Further, in the foregoing embodiment, the description has been given of the case that the power generation section 10 includes the six unit cells that are electrically connected to each other in series. However, the number of unit cells is not limited thereto. For example, the power generation section 10 may be composed of one unit cell, or may be composed of two or more given plurality of unit cells.

Further, in the foregoing embodiment, air supply to the oxygen electrode 13 is performed by natural ventilation. However, air may be forcefully supplied by using a pump or the like. In this case, oxygen or gas containing oxygen may be supplied instead of air.

Further, in the foregoing embodiment, the description has been given of the case that the fuel tank 40 containing the liquid fuel 41 is built in the fuel cell system 5. However, such a fuel tank may be detachable from the fuel cell system.

Further, in the foregoing embodiment, the description has been given of the direct methanol fuel cell system. However, the embodiment can be applied to other type of fuel cell system.

The fuel cell system of the embodiments are able to be suitably used for a mobile electronic device such as a mobile phone, an electronic camera, an electronic databook, and a PDA (Personal Digital Assistants).

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-11. (canceled)

12. A fuel cell system comprising:
a power generation section for performing power generation by being supplied a fuel and oxidant gas;
a piezoelectric pump section including a piezoelectric body and a check valve, and supplying a liquid fuel to the power generation section side;
a fuel vaporization section supplying a gas fuel to the power generation section by vaporizing the liquid fuel supplied from the piezoelectric pump section; and
a control section adjusting a supply amount of the liquid fuel supplied from the piezoelectric pump section by controlling oscillation frequency of the piezoelectric body,
wherein upper limit frequency at which opening/closing operation of the check valve is enabled is lower than mechanical resonance frequency of the piezoelectric body, and
wherein the control section exercises control so that the oscillation frequency of the piezoelectric body is in the vicinity of the resonance frequency in a certain case.

13. The fuel cell system according to claim 12, wherein a heat amount generated by oscillation of the oscillation frequency in the vicinity of the resonance frequency in the piezoelectric body is almost equal to vaporization heat of the liquid fuel.

14. The fuel cell system according to claim 12, wherein the fuel vaporization section is arranged between the piezoelectric pump section and the power generation section.

15. The fuel cell system according to claim 12, wherein the control section regularly exercises control so that the oscillation frequency of the piezoelectric body is in the vicinity of the resonance frequency.

16. The fuel cell system according to claim 12, wherein the control section exercises control so that the oscillation frequency of the piezoelectric body is in the vicinity of the resonance frequency in the case where temperature of the fuel vaporization section becomes lower than given threshold temperature.

17. The fuel cell system according to claim 12, wherein the resonance frequency is higher than an upper limit value in an audible frequency region.

18. The fuel cell system according to claim 12, wherein
the upper limit frequency is a value in the audible frequency region, and
the control section exercises control so that the oscillation frequency of the piezoelectric body is higher than the upper limit frequency in the audible frequency region in a certain case.

19. The fuel cell system according to claim 18 comprising:
a fuel tank containing the liquid fuel and being detachable,
wherein the control section exercises control so that the oscillation frequency of the piezoelectric body is higher than the upper limit frequency in the audible frequency region at the time of changing the fuel tank or at the time of injecting the liquid fuel into the fuel tank.

20. The fuel cell system according to claim 18, wherein the control section exercises control so that the oscillation frequency of the piezoelectric body is higher than the upper limit frequency in the audible frequency region at the time of power generation anomaly in the power generation section or at the time of detecting a precursory of the power generation anomaly.

21. The fuel cell system according to claim 12 comprising:
a fuel tank containing the liquid fuel.

22. An electronic device comprising
a fuel cell system including
a power generation section performing power generation by being supplied a fuel and oxidant gas;
a piezoelectric pump section including a piezoelectric body and a check valve, and supplying a liquid fuel to the power generation section side;
a fuel vaporization section supplying a gas fuel to the power generation section by vaporizing the liquid fuel supplied from the piezoelectric pump section; and
a control section for adjusting a supply amount of the liquid fuel supplied from the piezoelectric pump section by controlling oscillation frequency of the piezoelectric body,
upper limit frequency at which opening/closing operation of the check valve is enabled is lower than mechanical resonance frequency of the piezoelectric body, and
the control section exercises control so that the oscillation frequency of the piezoelectric body is in the vicinity of the mechanical resonance frequency in a certain case.
